(19) United States
(12) Patent Application Publication
(10) Pub. No.: US 2020/0386294 A1
(43) Pub. Date: Dec. 10, 2020

(54) RACK AND PINION DAMPER

(71) Applicant: Adam P. Plesniak, Huntington Beach, CA (US)

(72) Inventor: Adam P. Plesniak, Huntington Beach, CA (US)

(73) Assignee: Kinematics, LLC, Huntington Beach, CA (US)

(21) Appl. No.: 16/861,849

(22) Filed: Apr. 29, 2020

Related U.S. Application Data
(60) Provisional application No. 62/857,231, filed on Jun. 4, 2019.

(51) Int. Cl. F16F 15/16; F16H 19/04

(52) U.S. Cl. CPC F16F 15/161; F16H 19/04; F16F 15/162; F16F 2232/08; F16F 2222/12; F16F 2232/02; F16H 2019/046

(57) ABSTRACT

A rack and pinion damper provides controllable rotary motion of a pinion by actuating a rack inside a fluid disposed within a housing. The rack includes one or two cylindrical heads which further include flow-control mechanisms. Two plugs maybe threaded into the ends of the rack sections of the housing to limit a maximum clockwise rotation and a maximum counterclockwise rotation of the pinion. The pinion maybe coupled with an external unit, such as a torque tube, to control its rotational motion.

### CROSS REFERENCE TO RELATED APPLICATIONS

The present patent application is a formalization of a previously filed co-pending provisional patent application entitled “Rack and Pinion Damper,” filed on 2019, 04 Jun., as U.S. patent application Ser. No. 62857231 by the inventor(s) named in this application. This patent application claims the benefit of the filing date of the cited provisional patent application according, to the statutes and rules governing provisional patent applications, particularly 35 USC § 119 and 37 CFR § 1.78. The specification and drawings of the cited provisional patent application are specifically incorporated herein by reference.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

The present invention relates to a rack and pinion damper and a method of damping and/or controlling the rotary motion of the pinion. In particular, a damper includes a pinion whose teeth engage the teeth of a rack to move the later inside a housing filled with fluid so as to dampen the rotational motion of the pinion. The rack and pinion are slidably and rotatably secured within the housing, respectively. A maximum clockwise and a maximum counterclockwise rotation of the pinion is further controlled by including two plugs at the two ends of the rack section of the housing. The pinion may be coupled with a torque tube that is commonly utilized in solar trackers.

### BACKGROUND

A damper is a mechanism which uses the viscous properties of certain fluids to resist motion. The frictional forces developed during motion of such fluids are proportional to the velocity of the fluid. In other words, the faster the motion of the fluid, the more resistive force are developed. Linear dampers are commonly used to control the linear speed of moving parts which are coupled to the damper. Linear Dampers are also used to control shock and vibration. Applications of linear dampers are found, for instance, in solar trackers, automotive manufacturing, and machine construction, to name a few.

A linear damper is commonly constructed by using a piston that moves within a viscous fluid contained in a cylindrical housing. One or more orifices or orifices that include valves within the piston are used to control the characteristics of the damper such as its response to resonant frequencies. Some rotary motion applications, such as actuation of solar trackers, have a need for motion dampening against fast acting or harmonic torques, such as wind buffering (activating at about 1.5 Hz). This need today is met through the use of linear dampers, see FIGS. 1A through 1D. These dampers are manufactured by companies such as Stabilus of Koblenz, Germany.

The devices work by forcing a dampening fluid such as hydraulic oil through a small orifice thereby creating a dampening force, for instance see piston 100 in FIG. 1A moving inside the cylinder that is filled with oil. FIG. 1B depicts a linear damper 102 that may be used for a solar tracker, seen in FIGS. 1C and 1D.

FIG. 1C shows a solar tracker having a solar panel 106 that is mounted onto a rotating axel 108 which, in turn, is coupled to a post 110. The solar panel 106 is coupled with a mounting tube 108 which rotates around an axial axis (not shown) to minimize the angle of incidence of Sun's radiation. A linear damper 104 is used to control and dampen the rotational motion of the solar panel 106. FIG. 1D shows a solar tracker having a solar panel 112 coupled with a torque tube 114 which rotates around an axial axis of an axel 115 making hard stops with a bracket 116 to limit its angle of rotation in the clockwise and counterclockwise directions. A liner damper, such as the linear damper 104 is used to control and dampen the rotational motion of the solar panel 112. However, this design, using a linear damper in a rotary motion application, is not ideal. The described invention aims to lower the cost and increase the performance through a new damper architecture to better deal with the core rotary motion. This new architecture can also replace existing components in solar trackers, including post-top rotation brackets seen in FIG. 1D.

An objective of the present design is to use a rack and pinion architecture to arrive at a rack and pinion damper that maybe used in a solar tracker to control its motion. In particular, a rack having one or two cylindrical heads engages the teeth of a pinion. The rack is contained within a housing and moves inside a fluid disposed within the housing, thereby, providing damping via one or more flow-control mechanisms, discussed below. The damper may further utilize two plugs at the ends of the rack section of the housing to further control the rotary motion of the pinion. The pinion maybe coupled with a rotating component that requires damping. This new design of a rack and pinion damper is ideal for use with a solar tracker that is coupled with a torque tube which is driven by a slew drive such as those available from Kinematics Manufacturing of Phoenix, Ariz.

### SUMMARY

In one aspect, a damper is disclosed wherein the damper comprises a housing comprising a rack section along an axial axis of the housing and a pinion section along a transverse axis of the housing, a rack comprising a first head and rack teeth, wherein the first head comprises one or more first-head flow-control mechanism, and wherein the rack is slidably secured within the rack section, a pinion comprising pinion teeth, operative to engage the rack teeth, wherein the pinion is rotatably secured within the pinion section, and a fluid disposed within the housing, wherein a rotation of the pinion around the transverse axis actuates the rack through the fluid along the axial axis, thereby, controlling the rotation of the pinion via the one or more first-head flow-control mechanism.

Preferably, the one or more first-head flow-control mechanism comprise at least one of an orifice through the first head and an orifice including a valve through the first head.

Preferably, the first head is cylindrical comprising one or more first-head grooves disposed circumferentially around an outer diameter of the first head, operative to receive one or more first-head sealing rings.

Preferably, the damper further comprises a first plug, and wherein the rack section further comprises a first distal section operative to receive the first plug, wherein the first plug is operative to limit a first axial motion of the rack in a first direction along the axial axis, thereby, controlling a first maximum rotation of the pinion in a first direction around the transverse axis via the first plug.

Preferably, the rack further comprises a second head comprising one or more second-head flow-control mechanism, thereby, further controlling the rotation of the pinion via the one or more second-head flow-control mechanism.

Preferably, the one or more second-head flow-control mechanism comprise at least one of an orifice through the second head and an orifice including a valve through the second head.

Preferably, the second head is cylindrical comprising one or more second-head grooves disposed circumferentially around an outer diameter of the second head, operative to receive one or more second-head sealing rings.

Preferably, the damper further comprises a second plug, and wherein the rack section further comprises a second distal section operative to receive the second plug, wherein the second plug, is operative to limit a second axial motion of the rack in a second direction along the axial axis, thereby, controlling a second maximum rotation of the pinion in a second direction around the transverse axis via the second plug.

Preferably, the pinion is coupled with a torque tube via two brackets.

Preferably, the pinion is rotatably secured within the pinion section via two bearings.

in another aspect, a method of damping is disclosed, wherein the method comprises providing a housing comprising a rack section along an axial axis of the housing and a pinion section along a transverse axis of the housing, providing a rack comprising a first head and rack teeth, wherein the first head comprises one or more first-head flow-control mechanism, and wherein the rack is slidably secured within the rack section, providing a pinion comprising pinion teeth, operative to engage the rack teeth, wherein the pinion is rotatably secured within the pinion section, and providing a fluid disposed within the housing, wherein a rotation of the pinion around the transverse axis actuates the rack through the fluid along the axial axis, thereby, controlling the rotation of the pinion via the one or more first-head flow-control mechanism.

Preferably, the one or more first-head flow-control mechanism comprise at least one of an orifice through the first head and an orifice including a valve through the first head.

Preferably, the method further comprises providing a first plug, and wherein the rack section further comprises a first distal section operative to receive the first plug, wherein the first plug is operative to limit a first axial motion of the rack in a first direction along the axial axis, thereby, controlling a first maximum rotation of the pinion in a first direction around the transverse axis via the first plug.

Preferably, the rack further comprises a second head comprising one or more second-head flow-control mechanism, thereby, further controlling the rotation of the pinion via the one or more second-head flow-control mechanism.

Preferably, the one or more second-head flow-control mechanism comprise at least one of an orifice through the second head and an orifice including a valve through the second head.

Preferably, the method further comprises providing a second plug, and wherein the rack section further comprises a second distal section operative to receive the second plug, wherein the second plug is operative to limit a second axial motion of the rack in a second direction along the axial axis, thereby, controlling a second maximum rotation of the pinion in a second direction around the transverse axis via the second plug.

Preferably, the pinion is coupled with a torque tube via two brackets.

In another aspect, a method of controlling rotary motion of a pinion is disclosed, wherein the pinion comprises pinion teeth, wherein the pinion is rotatably secured within a pinion section of a housing along a transverse axis of the housing, wherein the housing further comprises a rack section along an axial axis of the housing, wherein a rack is slidably secured within the rack section, wherein the rack comprises a first head and rack teeth, wherein the first head comprises one or more first-head flow-control mechanism, wherein the pinion teeth is operative to engage the rack teeth, the method comprising actuating the rack through a fluid disposed within the housing along the axial axis via the pinion, thereby, controlling a rotation of the pinion via the one or more first-head flow-control mechanism.

Preferably, the rack section further comprises a first distal section operative to receive a first plug, the method further comprising limiting a first axial motion of the rack in a first direction, along the axial axis, thereby, controlling a first maximum rotation of the pinion in a first direction around the transverse axis via the first plug.

Preferably, the rack further comprises a second head comprising one or more second-head flow-control mechanism, thereby, further controlling the rotation of the pinion via the one or more second-head flow-control mechanism, and wherein the rack section further comprises a second distal section operative to receive a second plug, the method further comprising limiting a second axial motion of the rack in a second direction along the axial axis, thereby, controlling a second maximum rotation of the pinion in a second direction around the transverse axis via the second plug.

### DESCRIPTION OF THE DRAWINGS

FIG. 1A shows a cross-sectional view of a conventional linear damper utilizing a piston, having orifices, moving inside a housing which is filled with fluid.

FIG. 1B shows a perspective view of a conventional linear damper, such as the damper shown in FIG. 1A that may be used for a solar tracker, seen in FIGS. 1C and 1D.

FIG. 1C shows a solar tracker having a solar panel whose rotary motion is dampened by a linear damper, such as the linear dampers shown in FIGS. 1A and 1B.

FIG. 1D shows a solar tracker having a solar panel coupled with a torque tube which rotates around an axial axis of an axel making hard stops with a bracket to limit its maximum clockwise rotation and maximum counterclockwise rotation.

FIG. 2A shows a front view of a preferred embodiment of a rack and pinion damper that is supported by two posts and which is coupled with a torque tube.

FIG. 2B shows a cross-sectional view of the damper shown in FIG. 1A, detailing the housing, the rack, the pinion, and the two plugs.

including its two heads

FIG. 2C shows the cross-sectional view of the damper shown in FIG. 1B where the pinion has reached its maximum clockwise rotation when the rack's second head makes contact with the second plug.

FIG. 2D shows the cross-sectional view of the damper shown in FIG. 1B where the pinion has reached its maximum counterclockwise rotation when the rack's first head makes contact with the first plug.

FIG. 2E shows an exploded view of a preferred embodiment of a rack and pinion damper further illustrating the components of the damper and how it may be supported by two posts and its coupling with torque tube.

FIG. 2F shows another exploded view of the damper shown in FIG. 2E.

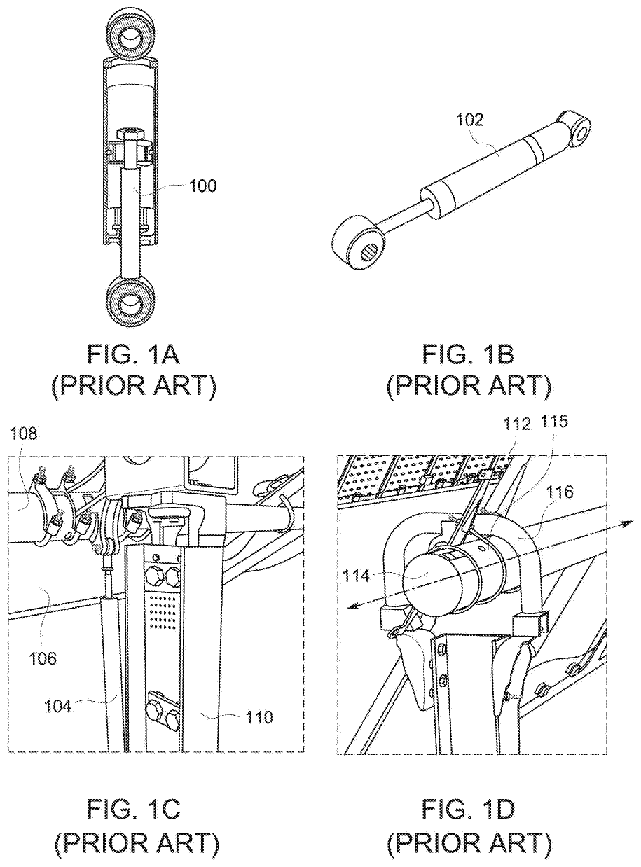

### DETAILED DESCRIPTION OF THE PRESENTLY PREFERRED EMBODIMENTS

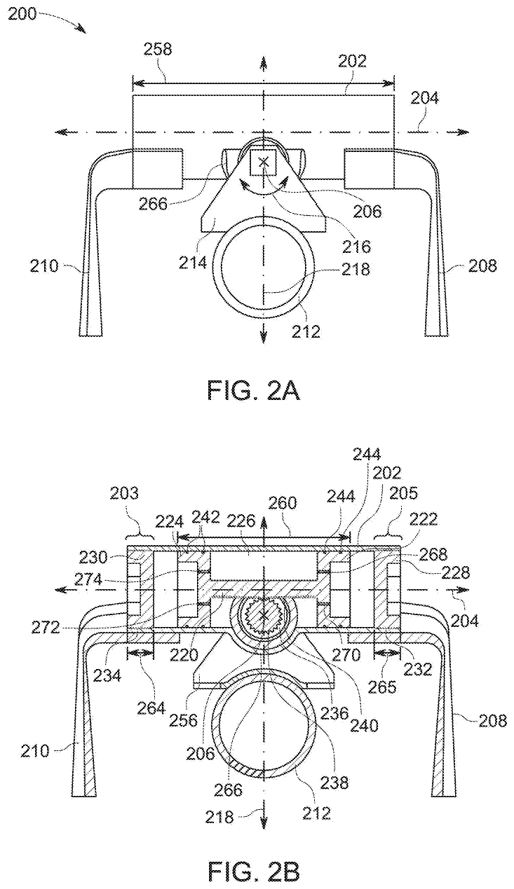

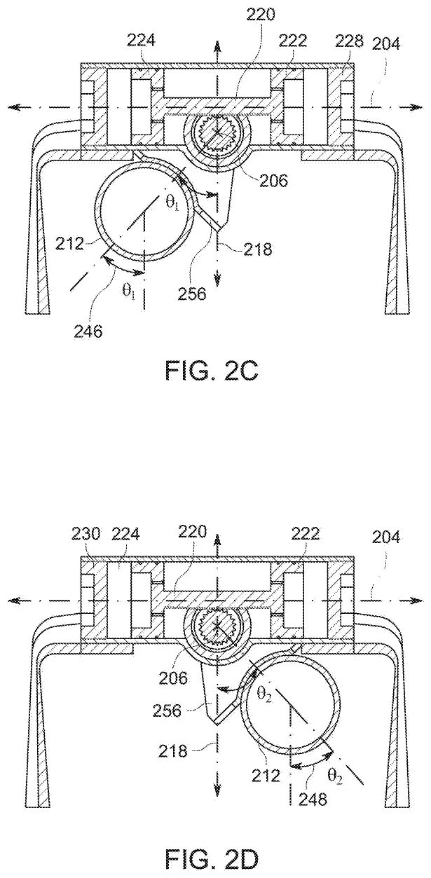

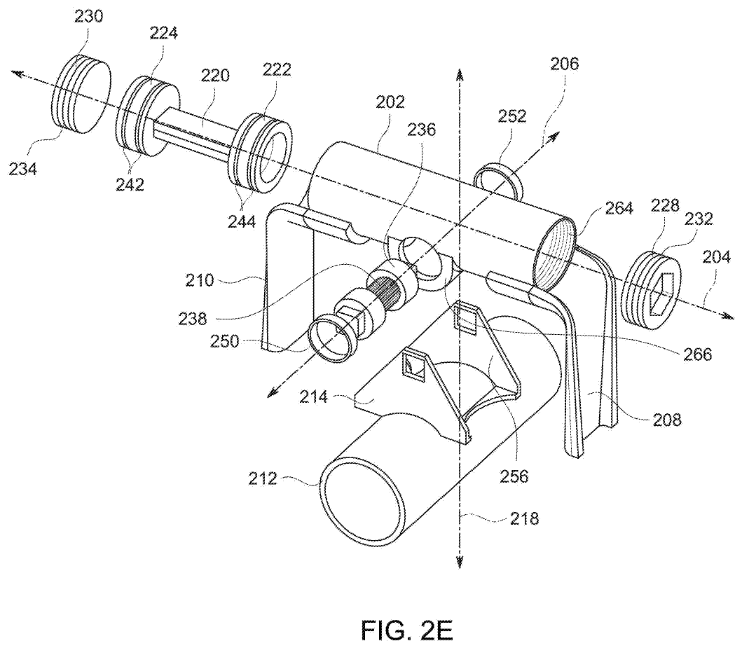

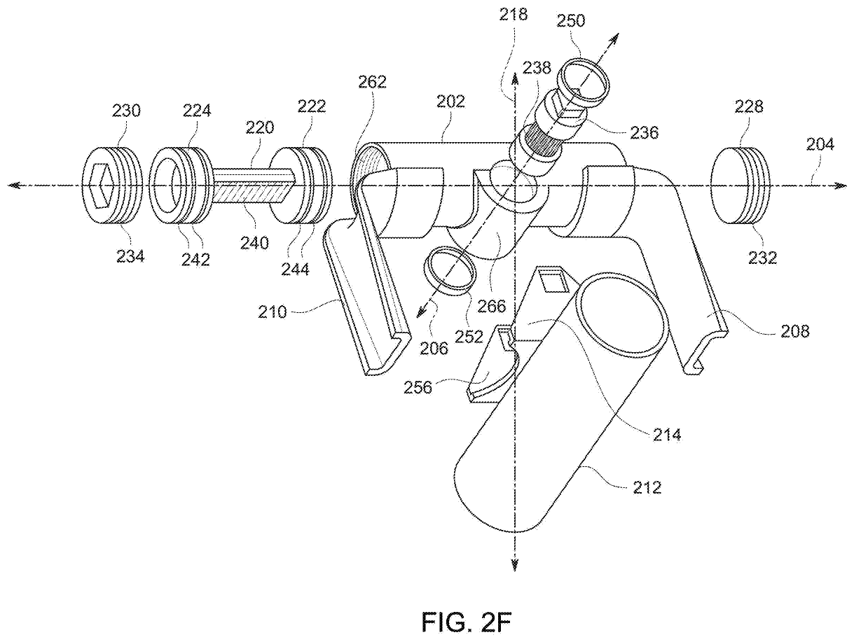

FIGS. 2A through 2F illustrate a preferred embodiment of a rack and pinion damper of the present invention. FIG. 2A depicts a front view 200 of a rack and pinion damper which may be used to dampen the rotational motion of a solar panel (not shown) that is rotated via a torque tube 212. In this preferred embodiment, the damper comprises a single-piece housing, having a tubular rack section 202 along an axial axis 204 and a tubular pinion section 266 along a transverse axis 206 which is normal to the plane of view 200. A rack (not visible in this view) is slidably secured within the rack section 202 and a pinion (not visible in this view) is rotatably secured within the pinion section 266, as shown in FIG. 2B. The pinion rotates around the transverse axis 206 in both clockwise and counterclockwise directions. The torque tube 212 rotates about the axis 206 in both directions 216 with respect to a vertical axis 218. The pinion is coupled with the torque tube 212 and rotates with it around the axis 206. In this preferred embodiment, the pinion is coupled with the torque tube 212 by a pair of brackets one of which 214 is shown in this view. Other means of coupling the torque tube 212 with the pinion are contemplated and are within the scope of this disclosure. The rack section 202 has a length LRH at 258 and is supported by two posts 208 and 210.

FIG. 2B depicts a cross-sectional view of the damper shown in FIG. 2A further illustrating the damper's components. The rack 220 having a length L_{R} at 260 comprises a first cylindrical head 224, a second cylindrical head 222, and rack teeth 240. As stated above, in an alternative embodiment, the rack 220 has only a single cylindrical head 222 or 224. The first cylindrical head 224 comprises one or more first-head grooves disposed circumferentially around an outer diameter of the first cylindrical head 224, operative to receive one or more first-head O-rings or piston rings. The second cylindrical head 222 comprises one or more second-head grooves disposed circumferentially around an outer diameter of the second cylindrical head 222, operative to receive one or more second-head O-rings. In this preferred embodiment, the first cylindrical head 224 has 2 grooves at 242 and the second cylindrical head 222 has 2 grooves at 244.

The rack 220 is slidably secured within the rack section 202 and can move in both directions to the left and right of the vertical axis 218 along the axial axis 204. The first cylindrical head 224 further includes one or more first-head flow-control mechanism which operate to control the flow of fluid within the damper. The second cylindrical head 222 further includes one or more second-head flow-control mechanism which operate to control the flow of fluid within the damper. In this preferred embodiment, the first-head flow-control mechanisms are a first orifice 274 and a second orifice 272, and the second-head flow-control mechanisms are a third orifice 268 and a fourth orifice 270. In an alternative embodiment, the flow-control mechanisms may further utilize valves such as spring loaded ball Valves, electronic valves that are one directional or bi-directional in order to provide additional fluid flow control for the damper.

The motion of the rack 220 within the rack section 202 in the positive and negative directions along the axial axis 204, i.e., to the right and, left of the vertical axis 218, is controlled by the one or more flow-control mechanisms 272, 274, 270, and 280. In this preferred embodiment, the one or more flow-control mechanisms 272, 274, 270, and 280 consist of four orifices. As the rack 220 moves to the right of the vertical axis 218, the fluid 226 is pushed to the left of the vertical axis 218 through the orifices 272, 274, 270, and 280 applying, a resistive force due to the viscosity of the fluid 226 whose magnitude depends on the speed of the rack 220. The greater the speed, the greater the resistive force. This effectively dampens the rotational motion of the pinion 236.

The damper further includes a first plug 230 of length L_{P1} at 264 that has a threaded section 234 which is disposed circumferentially around an outer diameter of the first plug 230. A first distal section 203 of the rack section 202 has a threaded section 262, shown in FIG. 2F, which is operative to receive the first plug 230. A second plug 228 of length L_{P2} at 265 has a threaded section 232 which is disposed circumferentially around an outer diameter of the second plug 228. A second distal section 205 of the rack section 202 has a threaded section 264, shown in FIG. 2E, which is operative to receive the second plug 228. In an alternative embodiment, the damper has only a single plug and the rack section 202 has only a single distal section threaded to receive the single plug, the other distal section of the rack section 202 is closed using a cap, a seal, and one or more fastening bolts.

A pinion 236 is substantially cylindrical and includes pinion teeth 238 which engage the rack teeth 240. The pinion 236 is rotatably secured within the pinion section 266 via two bearing/seal assemblies 250 and 252, shown in FIGS. 2E and 2F. Fluid 226 fills the volume within the housing of the damper. The fluid 226 is viscous fluid such as oil. As the pinion 236 rotates around the transverse axis 206, its teeth 238 engages the rack teeth 240, thereby, actuating the rack 220 to the left and right of the vertical axis 218. The flow-control mechanisms, discussed above, operate to control the motion of the rack 220, thereby, controlling the rotary motion of the pinion 236 resulting in the controlled motions of the torque tube 212. In an alternative embodiment, the damper does not include the first plug 230 and second plug 228. Accordingly, the rack section 202 may be submerged in a body of fluid and the movement of the rack 220 inside the rack section 220 controls the rotation of the pinion 236 via the one or more of the flow-control mechanisms 272, 274, 270, and 280.

FIGS. 2C and 2D illustrate the rotational movements of the torque tube 212 around the transverse axis 206. The plugs 230 and 228 operate to limit the axial motion of the rack 220 in the positive and negative directions, i.e., to the right and left of the vertical axis 218 along the axial axis 204. When the pinion 236 is rotated clockwise around the transverse axis 206, the pinion 236 actuates the rack 220 in the positive direction, i.e., to the right of the vertical axis 218 along the axial axis 204. When the pinion 236 is rotated counterclockwise around the transverse axis 206, the pinion 236 actuates the rack 220 in the negative direction, i.e., to the left of the vertical axis 218 along the axial axis 204.

When the rack 220 travels to the left of the vertical axis 218 and impinges upon the first plug 230, the rack 220 stops, thereby, limiting the maximum amount of counterclockwise rotation of the pinion 236 around the transverse axis 206. When the rack 220 travels to the right of the vertical axis 218 and impinges upon the second plug 228, the rack 220 stops, thereby, limiting the maximum amount of clockwise rotation of the pinion 236 around the transverse axis 206. As such, the plugs 230 and 228 operate to further control the rotation of the pinion 236.

In FIG. 2C the torque tube 212 is rotated clockwise by an angle θ₁ at 246 around the transverse axis 206 actuating the rack 220 to the right of the vertical axis 218. This is where the second head 222 impinges upon the second plug 228 which determines the maximum amount of clockwise rotation of the pinion 236. In FIG. 2D the torque tube 212 is rotated counterclockwise by an angle θ₂ at 246 around the transverse axis 206 actuating the rack 220 to the left of the vertical axis 218. This is where the first head 224 impinges upon the first plug 230 which determines the maximum amount of counterclockwise rotation of the pinion 236. In this preferred embodiment θ₁=θ₂=60°.

The maximum amount of clockwise rotation and the maximum amount of counterclockwise rotation of the pinion 236 can be calculated. The maximum clockwise rotation of the pinion 236 is determined by the following equation: θcw=((L_{RH}−L_{R})−2L_{P2})/2P_{D}. The maximum counterclockwise rotation of the pinion 236 is determined by the following equation: θcww=((L_{RH}−L_{R})−2L_{P1})/2P_{D}.

FIGS. 2E and 2F are exploded views of the damper components along with the torque tube 212 that is coupled with the pinion via the two brackets 214 and 256. The damper housing is supported by the two posts 208 and 210. These figures show the different components of the damper and how it may be used to control the rotary motions of a solar tracker (not shown).

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A damper, comprising:
(a) a housing comprising a rack section along an axial axis of the housing and a pinion section along a transverse axis of the housing;
(b) a rack comprising a first head and rack teeth, wherein the first head comprises one or more first-head flow-control mechanism, and wherein the rack is slidably secured within the rack section;
(c) a pinion comprising pinion teeth, operative to engage the rack teeth, wherein the pinion is rotatably secured within the pinion section; and
(d) a fluid disposed within the housing;
wherein a rotation of the pinion around the transverse axis actuates the rack through the fluid along the axial axis, thereby, controlling the rotation of the pinion via the one or more first-head flow-control mechanism.

2. The damper of claim 1, wherein the one or more first-head flow-control mechanism comprise at least one of an orifice through the first head and an orifice including a valve through the first head.

3. The damper of claim 1, wherein the first head is cylindrical comprising one or more first-head grooves disposed circumferentially around an outer diameter of the first head, operative to receive one or more first-head searing rings.

4. The damper of claim 1, further comprising:
(e) a first plug; and
wherein the rack section further comprises a first distal section operative to receive the first plug, wherein the first plug is operative to limit a first axial motion of the rack in a first direction along the axial axis, thereby, controlling a first maximum rotation of the pinion in a first direction around the transverse axis via the first plug.

5. The damper of claim 4, wherein the rack further comprises a second head comprising one or more second-head flow-control mechanism, thereby, further controlling the rotation of the pinion via the one or more second-head flow-control mechanism.

6. The damper of claim 5, wherein the one or more second-head flow-control mechanism comprise at least one of an orifice through the second head and an orifice including a valve through the second head.

7. The damper of claim 5, wherein the second head is cylindrical comprising one or more second-head grooves disposed circumferentially around an outer diameter of the second head, operative to receive one or more second-head sealing rings.

8. The damper of claim 5, further comprising:
(f) a second plug; and
wherein the rack section further comprises a second distal section operative to receive the second plug, wherein the second plug is operative to limit a second axial motion of the rack in a second direction along the axial axis, thereby, controlling a second maximum rotation of the pinion in a second direction around the transverse axis via the second plug.

9. The damper of claim 1, wherein the pinion is coupled with a torque tube via two brackets.

10. The damper of claim 1, wherein the pinion is rotatably secured within the pinion section via two bearings.

11. A method of damping, comprising:
(a) providing a housing comprising a rack section along an axial axis of the housing and a pinion section along a transverse axis of the housing;
(b) providing a rack comprising a first head and rack teeth, wherein the first head comprises one or more first-head flow-control mechanism, and wherein the rack is slidably secured within the rack section;
(c) providing a pinion comprising pinion teeth, operative to engage the rack teeth, wherein the pinion is rotatably secured within the pinion section; and
(d) providing a fluid disposed within the housing;
wherein a rotation of the pinion around the transverse axis actuates the rack through the fluid along the axial axis, thereby, controlling the rotation of the pinion via the one or more first-head flow-control mechanism.

12. The method of claim 11, wherein the one or more first-head flow-control mechanism comprise at least one of an orifice through the first head and an orifice including a valve through the first head.

13. The method of claim 11, further comprising:
(e) providing a first plug; and
wherein the rack section further comprises a first distal section operative to receive the first plug, wherein the first plug is operative to limit a first axial motion of the rack in a first direction along the axial axis, thereby, controlling a first maximum rotation of the pinion in a first direction around the transverse axis via the first plug.

14. The method of claim 3, wherein the rack further comprises a second head comprising one or more second-head flow-control mechanism, thereby, further controlling the rotation of the pinion via the one or more second-head flow-control mechanism.

15. The method of claim 4, wherein the one or more second-head flow-control mechanism comprise at least one of an orifice through the second head and an orifice including a valve through the second head.

16. The method of claim 4, further comprising:
(f) providing a second plug; and
wherein the rack section further comprises a second distal section operative to receive the second plug, wherein the second plug is operative to limit a second axial motion of the rack in a second direction along the axial axis, thereby, controlling a second maximum rotation of the pinion in a second direction around the transverse axis via the second plug.

17. The method of claim 11, wherein the pinion is coupled with a torque tube via two brackets.

18. A method of controlling rotary motion of a pinion comprising pinion teeth, wherein the pinion is rotatably secured within a pinion section of a housing along a transverse axis of the housing, wherein the housing further comprises a rack section along an axial axis of the housing, wherein a rack is slidably secured within the rack section, wherein the rack comprises a first head and rack teeth, wherein the first head comprises one or more first-head flow-control mechanism, wherein the pinion teeth is operative to engage the rack teeth, the method comprising:
(a) actuating the rack through a fluid disposed within the housing along the axial axis via the pinion, thereby, controlling a rotation of the pinion via the one or more first-head flow-control mechanism.

19. The method of claim 18, wherein the rack section further comprises a first distal section operative to receive a first plug, the method further comprising:
(b) limiting a first axial motion of the rack in a first direction along the axial axis, thereby, controlling a first maximum rotation of the pinion in a first direction around the transverse axis via the first plug.

20. The method of claim 2, wherein the rack further comprises a second head comprising one or more second-head flow-control mechanism, thereby, further controlling the rotation of the pinion via the one or more second-head flow-control mechanism, and wherein the rack section further comprises a second distal section operative to receive a second plug, the method further comprising:
(c) limiting a second axial motion of the rack in a second direction along the axial axis, thereby, controlling a second maximum rotation of the pinion in a second direction around the transverse axis via the second plug.
